(19) United States
(12) Patent Application Publication
(10) Pub. No.: US 2008/0065780 A1
(43) Pub. Date: Mar. 13, 2008

(54) Information processing apparatus, information processing method, and program

(75) Inventors: Tomoaki Iwata, Tokyo (JP); Masanori Muroya, Tokyo (JP); Taku Inoue, Kanagawa (JP); Taro Suito, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/899,830

(22) Filed: Sep. 6, 2007

(30) Foreign Application Priority Data
Sep. 11, 2006 (JP) P2006-245390

(51) Int. Cl. G06F 15/16

(52) U.S. Cl. 709/231

(57) ABSTRACT

An information processing apparatus includes an obtaining unit configured to obtain stream data, the stream data including one or more events captured by an imaging device and arranged in an order that is independent of a time order of time periods of capturing of the individual events, and to obtain additional information including start times and end times of the time periods of capturing of the individual events; a recording controller configured to exercise control so that the stream data obtained by the obtaining unit is recorded on a recording medium; and a generating unit configured to generate a date playlist on the basis of the additional information, the date playlist allowing individual reproduction of titles associated with individual dates, each of the titles being a collection of one or more events having the same date and sorted in order of time among the events captured by the imaging device.

### CROSS REFERENCES TO RELATED APPLICATIONS

The present invention contains subject matter related to Japanese Patent Application JP 2006-245390 filed in the Japanese Patent Office on Sep. 11, 2006, the entire contents of which are incorporated herein by reference.

### BACKGROUND OF THE INVENTION

1. Field of the Invention

The present invention relates to information processing apparatuses, information processing methods, and programs. More specifically, the present invention relates to an information processing apparatus, an information processing method, and a program with which when a recording medium has recorded thereon stream data including one or more events captured by an imaging device and arranged in an order that is independent of a time order of time periods of capturing of the individual events, the stream data can be reproduced from the recording medium in consideration of the time periods of capturing of the individual events.

2. Description of the Related Art

Video content captured by a user using a camcoder is recorded on a digital video tape in the form of video data. Recently, techniques for dubbing such video content from a digital video tape to an optical disc having a better storage performance are coming to be used.

With the dubbing techniques, video content reproduced from a digital video tape in a single dubbing operation is recorded on an optical disc as a single original title at a location corresponding to a stream location on the digital video tape.

That is, when dubbing is executed a plurality of times, for example, when dubbing from a plurality of digital video tapes to an optical disc is executed individually, a plurality of original titles are recorded on the optical disc.

In view of this situation, playlists for reproducing a plurality of original titles recorded on an optical disc in a specific order exist, as described, for example, in Japanese Unexamined Patent Application Publication No. 2006-172615.

### SUMMARY OF THE INVENTION

However, video content recorded on a digital video tape in the form of video data by a single imaging operation by a user (hereinafter referred to as an event) can be recorded at any location on the digital video tape. More specifically, the user can record an event in an area starting from any location on the tape by rewinding or fast-forwarding the digital video tape as appropriate. Thus, individual events can be recorded separately on the digital video tape regardless of an order of the time periods of capturing of the individual events. In such cases, video content reproduced from the digital video tape are reproduced in order of the locations of the individual events recorded on the digital video tape, regardless of the time periods of capturing of the individual events. Thus, when such video content is dubbed from the digital video tape to an optical disc and recorded as a single original title, video content reproduced according to the original title is also reproduced in order of the locations of the individual events recorded on the digital video tape, regardless of the time periods of capturing of the individual events.

In view of this situation, a demand for reproducing video content in consideration of time periods of capturing of individual events has arisen recently. However, existing techniques, including those described in Japanese Unexamined Patent Application Publication No. 2006-172615, do not satisfy the demand sufficiently.

This problem also occurs in a case where stream data including one or more events captured by an imaging device and arranged in an order that is independent of a time order of time periods of capturing of the individual events is recorded on a certain recording medium as well as a case where video content reproduced from a digital video tape is dubbed on an optical disc.

It is desired that when a recording medium has recorded thereon stream data including one or more events captured by an imaging device and arranged in an order that is independent of a time order of time periods of capturing of the individual events, the stream data can be reproduced from the recording medium in consideration of the time periods of capturing of the individual events.

An information processing apparatus according to an embodiment of the present invention includes an obtaining unit configured to obtain stream data, the stream data including one or more events captured by an imaging device and arranged in an order that is independent of a time order of time periods of capturing of the individual events, and to obtain additional information including start times and end times of the time periods of capturing of the individual events; a recording controller configured to exercise control so that the stream data obtained by the obtaining unit is recorded on a recording medium; and a generating unit configured to generate a date playlist on the basis of the additional information obtained by the obtaining unit, the date playlist allowing individual reproduction of titles associated with individual dates, each of the titles being a collection of one or more events having the same date and sorted in order of time among the events captured by the imaging device.

The recording controller may further exercise control so that the date playlist generated by the generating unit is recorded on the recording medium.

When the generating unit generates the playlist, the generating unit may exclude one or more events for each of which the obtaining unit failed to obtain at least one of the start time and the end time among the events captured by the imaging device.

When the generating unit generates the playlist, the generating unit may exclude one or more events for each of which the time period of capturing has a length less than or equal to a predetermined time among the events captured by the imaging device.

An information processing method according to an embodiment of the present invention is an information processing method of an information processing apparatus including an obtaining unit configured to obtain stream data, the stream data including one or more events captured by an imaging device and arranged in an order that is independent of a time order of time periods of capturing of the individual events, and obtaining additional information including start times and end times of the time periods of capturing of the individual events, and including a recording controller configured to exercise control so that the stream data obtained by the obtaining unit is recorded on a recording medium. The information processing method comprising the step of generating a date playlist on the basis of the additional information obtained by the obtaining unit, the date playlist allowing individual reproduction of titles associated with individual dates, each of the titles being a collection of one or more events having the same date and sorted in order of time among the events captured by the imaging device.

A program according to an embodiment of the present invention is a program corresponding to the information processing method described above.

With the information processing apparatus, the information processing method, and the program according to these embodiments of the present invention, stream data is obtained, the stream data including one or more events captured by an imaging device and arranged in an order that is independent of a time order of time periods of capturing of the individual events, and additional information including start times and end times of the time periods of capturing of the individual events is obtained. Furthermore, the stream data is recorded on a recording medium. Furthermore, a date playlist is generated on the basis of the additional information, the date playlist allowing individual reproduction of titles associated with individual dates, each of the titles being a collection of one or more events having the same date and sorted in order of time among the events captured by the imaging device.

As described above, it is possible to record stream data on a certain recording medium, the recording medium including one or more events captured by an imaging device and arranged in an order that is independent of a time order of time periods of capturing of the individual events, the stream data can be reproduced from the recording medium in consideration of the time periods of capturing of the individual events. That is, when a first recording medium has recorded thereon stream data, it is possible to dub the stream data from the first recording medium to a second recording medium. Particularly, when the stream data is reproduced from the second recording medium, the stream data can be reproduced in consideration of the time periods of capturing of the individual events.

### BRIEF DESCRIPTION OF THE DRAWINGS

FIG. 1 is a block diagram showing an example configuration of a recording and reproducing apparatus according to an embodiment of the present invention;

FIG. 2 is a diagram showing an example of a method of generating a date playlist in the embodiment;

FIG. 3 is a flowchart showing an example of a playlist generating process for dubbing, executed by the recording and reproducing apparatus shown in FIG. 1;

FIG. 4 is a flowchart showing an example of a playlist generating process for dubbing, executed by the recording and reproducing apparatus shown in FIG. 1;

FIG. 5 is a flowchart showing an example of a playlist generating process for dubbing, executed by the recording and reproducing apparatus shown in FIG. 1;

FIG. 6 is a diagram showing a specific example for explaining processing executed in step S16 shown in FIG. 5;

FIG. 7 is a diagram showing a specific example for explaining processing executed in step S16 shown in FIG. 5;

FIG. 8 is a diagram showing a specific example for explaining processing executed in step S16 shown in FIG. 5;

FIG. 9 is a diagram showing a specific example for explaining processing executed in step S16 shown in FIG. 5;

FIG. 10 is a flowchart for explaining an example of a playlist generating process for dubbing, executed by the recording and reproducing apparatus shown in FIG. 1;

FIG. 11 is a diagram for explaining an example of setting of a name of each playlist title in a date playlist;

FIG. 12 is a diagram showing an example of the structure of data arrangement in a BD;

FIG. 13 is a diagram showing an example of relationship among “PLAYLIST”, “CLIPINF”, and “STREAM” shown in FIG. 12;

FIG. 14 is a diagram showing an example of the structure of data arrangement in a DVD; and

FIG. 15 is a diagram showing an example of relationship between “VR_MANGR.IFO” and “VR_STILL.VRO” shown in FIG. 14.

### DESCRIPTION OF THE PREFERRED EMBODIMENTS

Before describing embodiments of the present invention, examples of correspondence between the features of the present invention and embodiments described in the specification or shown in the drawings will be described below. This description is intended to assure that embodiments supporting the present invention are described in this specification or shown in the drawings. Thus, even if a certain embodiment is not described in this specification or shown in the drawings as corresponding to certain features of the present invention, that does not necessarily mean that the embodiment does not correspond to those features. Conversely, even if an embodiment is described or shown as corresponding to certain features, that does not necessarily mean that the embodiment does not correspond to other features.

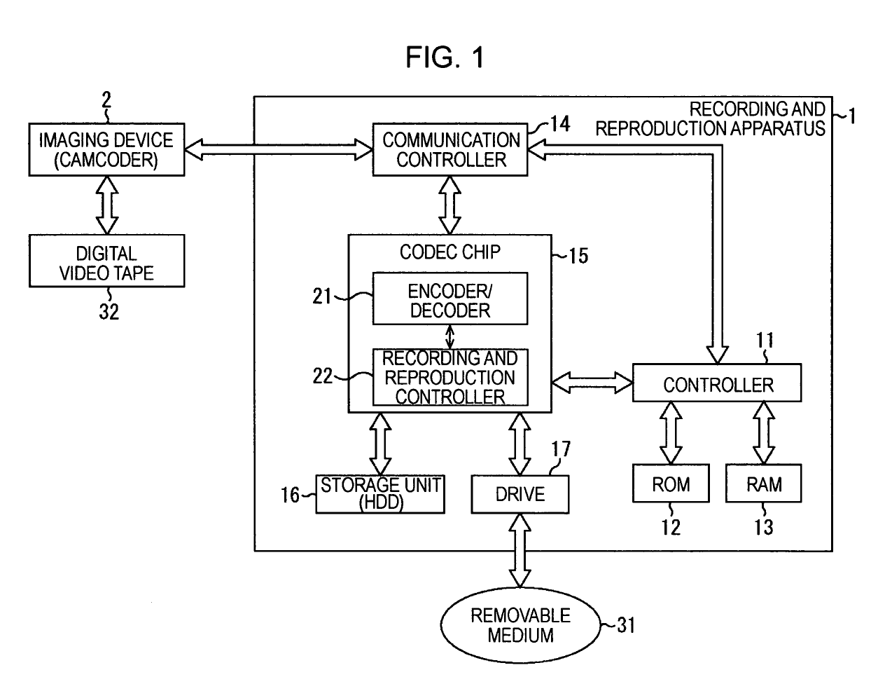

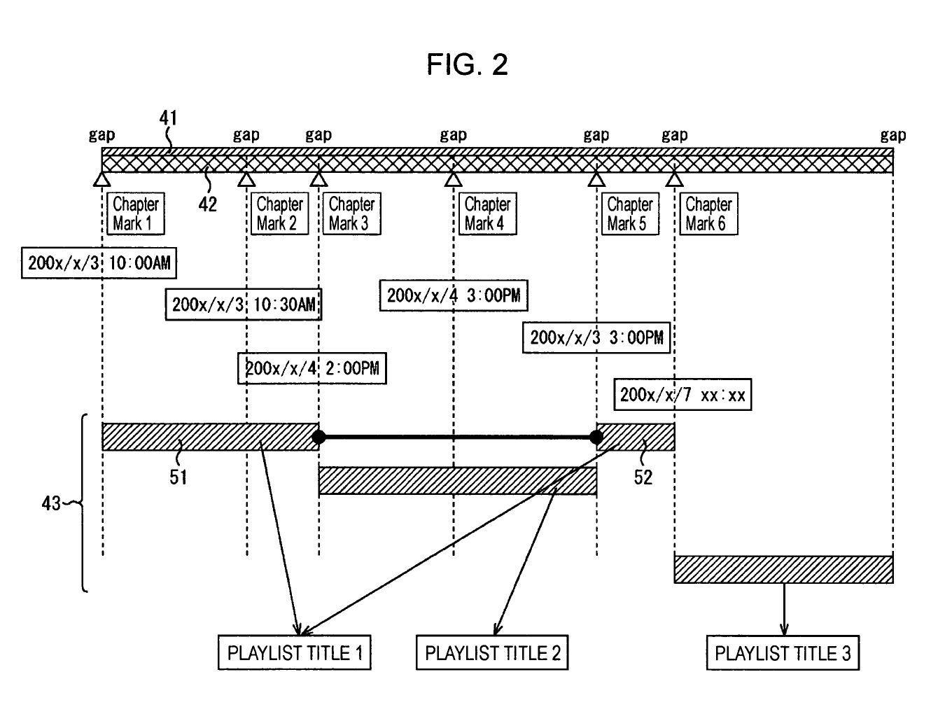

An information processing apparatus (e.g., a recording and reproducing apparatus 1 shown in FIG. 1) according to an embodiment of the present invention includes obtaining unit (e.g., a communication controller 14 shown in FIG. 1) configured to obtain stream data (e.g., a video stream represented by a bar 41 shown in FIG. 2, such as a video stream recorded on a digital video tape 32 shown in FIG. 1, each event being defined by two gaps in the example shown in FIG. 2), the stream data including one or more events captured by an imaging device (e.g., an imaging device 2, also referred to as a camcoder 2) and arranged in an order that is independent of a time order of time periods of capturing of the individual events, and to obtain additional information including start times and end times (e.g., times indicated in rectangles below individual gaps in FIG. 2) of the time periods of capturing of the individual events; recording controller (e.g., a codec chip 15 shown in FIG. 1) configured to exercise control so that the stream data obtained by the obtaining unit is recorded on a recording medium (e.g., a removable medium 31 shown in FIG. 1); and generating unit (e.g., a controller 11 shown in FIG. 1) for generating a date playlist (e.g., a date playlist 43 including playlist titles 1 to 3 in an example shown in FIG. 2) on the basis of the additional information obtained by the obtaining unit, the date playlist allowing individual reproduction of titles associated with individual dates, each of the titles (e.g., a playlist title 1 created by sorting in order of time and combining events having a date “200x/x/3”, in the example shown in FIG. 2) being a collection of one or more events having the same date and sorted in order of time among the events captured by the imaging device.

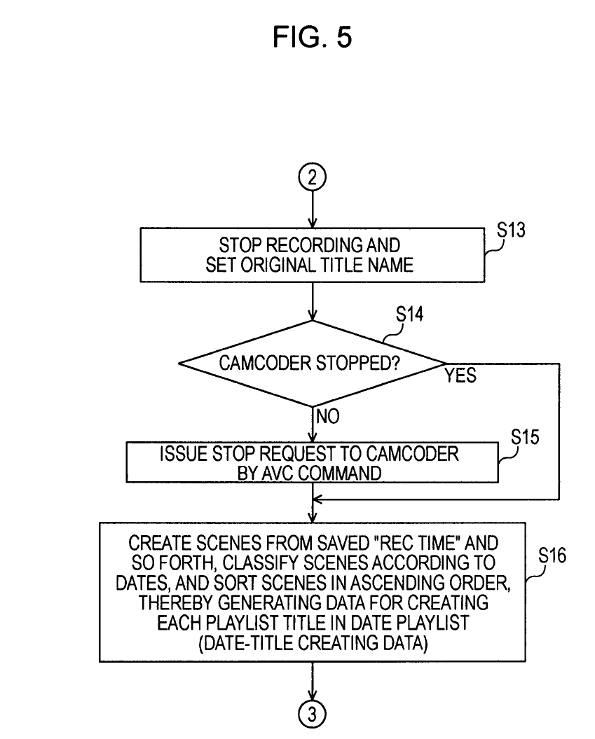

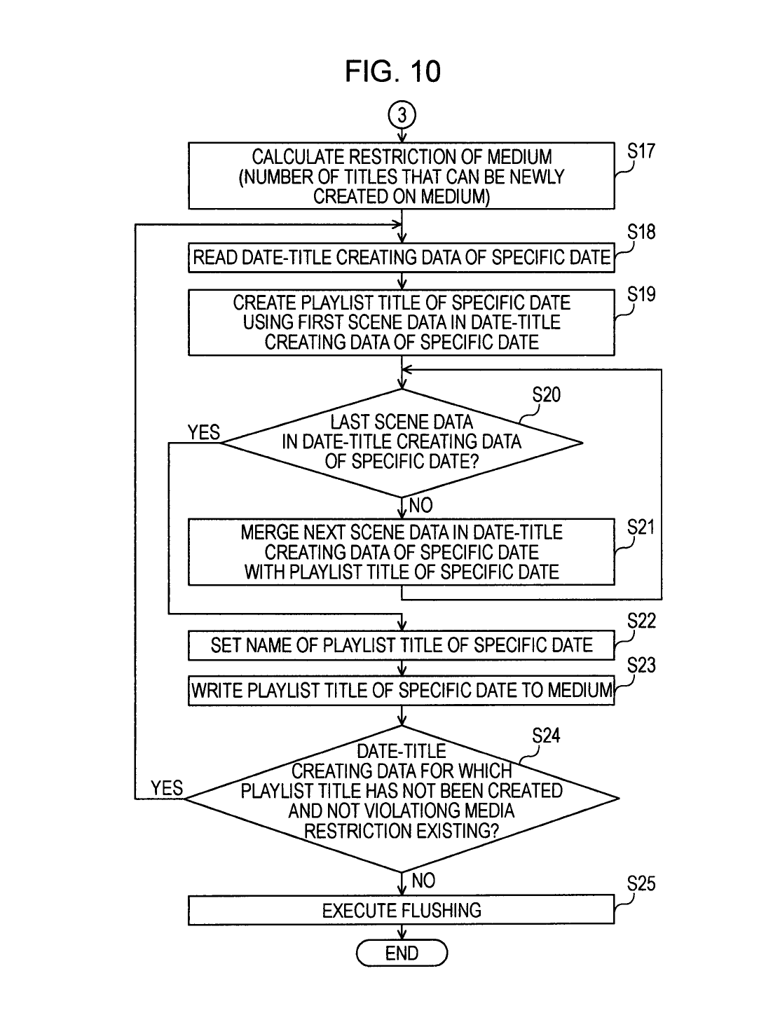

An information processing method according to an embodiment of the present invention is an information processing method of an information processing apparatus (e.g., the recording and reproducing apparatus 1 shown in FIG. 1) including an obtaining unit (e.g., the communication controller 14 shown in FIG. 1) configured to obtain stream data (e.g., the video stream represented by the bar 42 shown in FIG. 2, such as a video stream recorded on the digital video tape 32 shown in FIG. 1, each event being defined by two gaps in the example shown in FIG. 2), the stream data including one or more events captured by an imaging device (e.g., the imaging device 2, also referred to as the camcoder 2) and arranged in an order that is independent of a time order of time periods of capturing of the individual events, and obtaining additional information including start times and end times (e.g., the times indicated in the rectangles below the individual gaps in FIG. 2) of the time periods of capturing of the individual events, and including a recording controller (e.g., the codec chip 15 shown in FIG. 1) configured to exercise control so that the stream data obtained by the obtaining unit is recorded on a recording medium (e.g., the removable medium 31 shown in FIG. 1), the information processing method comprising the step (e.g., step S16 in FIG. 5 to step S24 in FIG. 10) of generating a date playlist (e.g., the date playlist 43 including the playlist titles 1 to 3 in the example shown in FIG. 2) on the basis of the additional information obtained by the obtaining unit, the date playlist allowing individual reproduction of titles associated with individual dates, each of the titles (e.g., a playlist title 1 created by sorting in order of time and combining events having a date “200x/x/3” in the example shown in FIG. 2) being a collection of one or more events having the same date and sorted in order of time among the events captured by the imaging device.

A program according to an embodiment of the present invention is a program including the step of the information processing method described above, and is executed, for example, by a computer including a controller 11 shown in FIG. 1.

Next, embodiments of the present invention will be described with reference to the drawings.

In this specification, “video signals” refers to not only signals corresponding to video content itself, but also include signals that are used (e.g., listened to) by a user (e.g., audio data) together with video content. That is, data that is recorded or reproduced actually includes audio data or the like as well as video content, and the data that is recorded or reproduced, including audio data or the like, will be simply referred to as video content for simplicity of description.

FIG. 1 is a block diagram showing an example of the configuration of a recording and reproducing apparatus according to an embodiment of the present invention.

Referring to FIG. 1, a recording and reproducing apparatus 1 is capable of obtaining video signals supplied from, for example, an external imaging device 2 (hereinafter referred to as a camcoder 2), and recording the video signals on a removable medium 31. When the video signals supplied from the camcoder 2 are video signals reproduced from a digital video tape 32, the recording of the video signals on the removable medium 31 means dubbing (transfer) of the video signals from the digital video tape 32 to the removable medium 31. That is, the recording and reproducing apparatus 1 is capable of dubbing video content from the digital video tape 32 to the removable medium 31.

The recording and reproducing apparatus 1 includes a controller 11, a read-only memory (ROM) 12, a random access memory (RAM) 13, a communication controller 14, a codec chip 15, a storage unit 16, and a drive 17.

The controller 11 controls the operation of the recording and reproducing apparatus 1 as a whole. For example, the controller 11 controls the operations of the codec chip 15, the communication controller 14, and so forth, which will be described later. When exercising the control, the controller 11 can execute various types of processing according to programs stored in the ROM 12 or the storage unit 16 as needed. The RAM 13 stores programs executed by the controller 11, data, and so forth as needed.

The communication controller 14 controls communications with external devices. In the case of the example shown in FIG. 1, the communication controller 14 controls communications with the camcoder 2 connected by a dedicated i.LINK cable. i.Link is a trademark of Sony Corporation, which is the assignee of this application, and it is a high-speed digital serial interface for the IEEE (Institute of Electrical and Electronics Engineers) 1394. Thus, the communication controller 14 can relay various types of information (video signals, control signals, and so forth) exchanged according to the IEEE 1394 standard between the camcoder 2 and the controller 11, between the camcoder 2 and the codec chip 15, and so forth. For example, the communication controller 14 can send control signals (e.g., AVC commands, which will be described later) provided from the controller 11 to the camcoder 2 to control various operations of the camcoder 2, such as starting and stopping.

Furthermore, for example, when video signals have been supplied from the camcoder 2, the communication controller 14 can supply the video signals to the codec chip 15. Conversely, when video signals have been supplied from the codec chip 15, the communication controller 14 can supply the video signals to the camcoder 2.

Furthermore, although not shown, for example, the communication controller 14 can receive broadcast signals (e.g., terrestrial analog broadcast signals, broadband-satellite analog broadcast signals, terrestrial digital broadcast signals, or broadcast-satellite digital broadcast signals), and sends corresponding video signals of television programs to the codec chip 15.

Furthermore, the communication controller 14 is capable of connecting to a network, such as the Internet, and the communication controller 14 can receive, for example, certain data transmitted by multicasting via a certain network and supply the data to the codec chip 15.

The codec chip 15 includes an encoder/decoder 21 and a recording and reproduction controller 22.

In a recording operation, the encoder/decoder 21 encodes video signals supplied from the communication controller 14, for example, according to an MPEG (Moving Picture Experts Group) compression algorithm, and supplies the resulting encoded data (hereinafter referred to as video data) to the recording and reproduction controller 22. Then, the recording and reproduction controller 22 stores the video data in the storage unit 16 or records the video data on the removable medium 31 via the drive 17. That is, video content is recorded on the removable medium 31 or stored in the storage unit 16 in the form of video data.

In this embodiment, for example, when video content is dubbed from the digital video tape 32 to the removable medium 31, as a playlist of the video content, the controller 11 automatically generates a playlist in which in addition to original titles, titles can be managed on a basis of individual dates of recording on the digital video tape 32, i.e., on a basis of individual dates of imaging by the imaging device 2 when video content captured by the imaging device 2 is recorded on the digital video tape 32 (hereinafter referred to as a date playlist), and records the date playlist on the removable medium 31 via the drive 17. However, processing for creating the date playlist need not necessarily be executed by the controller 11, and may be executed, for example, by the recording and reproduction controller 22. Furthermore, although the date playlist is saved on the removable medium 31 in this embodiment, without limitation to this embodiment, the date playlist may be saved within the recording and reproducing apparatus 1, for example, in the storage unit 16. The date playlist will be described later in detail with reference to FIG. 2 and the subsequent figures.

In a recording operation, the recording and reproduction controller 22 reads video data from the storage unit 16 or reads video data from the removable medium 31 via the drive 17, and supplies the video data to the encoder/decoder 21. Then, the encoder/decoder 21 decodes the video data according to a decoding algorithm corresponding to the compression algorithm described earlier, and supplies the resulting video signals to the communication controller 14.

At this time, if the removable medium 31 has the date playlist recorded thereon, the recording and reproduction controller 22 can read the corresponding video data from the removable medium 31 via the drive 17 according to the date playlist, and supply the video data to the encoder/decoder 21. The date playlist will be described later in detail with reference to FIG. 2 and the subsequent figures.

The storage unit 16 is formed of, for example, a hard disk drive (HDD), and stores various types of information, such as video data supplied from the codec chip 15. Furthermore, the storage unit 16 reads video data or the like stored therein, and supplies the video data to the codec chip 15.

The drive 17 records video data or the like supplied from the codec chip 15 on the removable medium 31. Furthermore, the drive 17 reads video data or the like recorded on the removable medium 31 and supplies the video data or the like to the codec chip 15.

The removable medium 31 may be, for example, a magnetic disc (e.g., a flexible disc), an optical disc (e.g., a compact disc read-only memory (CD-ROM), a digital versatile disc (DVD), or a Blu-ray disc (BD)), a magneto-optical disc (e.g., a mini disc (MD)), a magnetic tape, or a semiconductor memory.

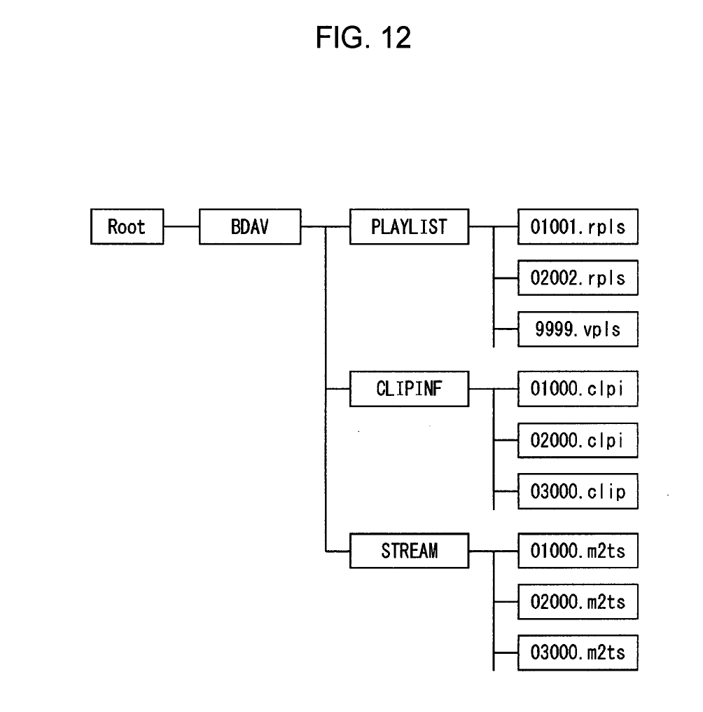

It is assumed herein that the removable medium 31 in this embodiment is a DVD or a BD. The data structure of video data or playlists differs between DVD and BD. This difference will be described later with reference to FIGS. 12 to 15.

Next, an overview of the date playlist will be described with reference to FIG. 2.

In an example shown in FIG. 2, regarding video content that is to be dubbed, a bar 41 indicates the location of a stream on the digital video tape 32, and a bar 42 indicates the location of a stream on the removable medium 31.

“gap” above the bar 41 indicates a gap point of “REC TIME” (recording date and time information) on the digital video tape 32. “Chapter MarkK” (where k is an integer) and a triangle mark placed in the proximity thereof indicate a location at which a chapter mark is written (chapter mark point), i.e., a point corresponding to the beginning of a chapter. That is, in this embodiment, a chapter mark is written at each gap point.

Furthermore, in a rectangle shown below “Chapter MarkK”, the content of “REC TIME” of “gap” associated with the “Chapter MarkK”, i.e., the date and time of recording of the gap point (year/month/day time AM or PM) is shown. More specifically, of two events preceding and succeeding the gap point, the date and time of recording of the succeeding event is shown. For example, an event refers to video content captured by the camcoder 2 during a single imaging operation, i.e., between an imaging start operation and an imaging end operation, and recorded on the digital video tape 32 in the form of video data. Thus, the recording date and time can be considered as an imaging date and time representing an imaging time period of the event. That is, “REC TIME” can be considered as information representing an imaging date and time from the viewpoint of imaging. For example, the video content in the period between the “gap” associated with “Chapter Mark1” and the “gap” associated with “Chapter Mark2” constitutes an event, and the imaging start time of the event is the “REC TIME” of the “gap” associated with “Chapter Mark1”, i.e., “200x/x/3 10:00 AM”.

In this embodiment, as shown below the bars 41 and 42, a date playlist 43 including playlist titles 1 to 3 is generated.

In this specification, a set of one or more titles created according to rules (restrictions) described later will be referred to as a playlist title, and a set of one or more playlist titles will be referred to as a date playlist. That is, although a single title is sometimes referred to as a playlist title, in this specification, a playlist title is clearly distinguished from a date playlist, which refers to a set of one or more playlist titles.

Now, rules for creating each playlist title in a date playlist will be described.

Basically, a playlist title is information for reproducing one or more scenes having imaging time periods with the same date and arranged in ascending order of time. A scene herein refers to video content between “Chapter MarkK” to “Chapter MarkK+1”, i.e., video content corresponding to an event identified by the “gap” associated with “Chapter MarkK” and the “gap” associated with “Chapter MarkK+1”.

In this case, when a plurality of scenes having imaging time periods with the same date exist, even when the locations of streams corresponding to the plurality of scenes on the removable medium 31 are separate, the plurality of scenes are sorted in order of time and combined into a single playlist title. This constitutes a first rule.

In the case of the example shown in FIG. 2, on the removable medium 31, as indicated by the bar 42, scenes having the date “200x/x/3”, namely, a first set of scenes 51 starting at “200x/x/3 10:00 AM” and a second set of scenes 52 starting at “200x/x/3 3:00 PM”, are located separately without continuity. Even in this case, according to the first rule, the first set of scenes 51 and the second set of scenes 52 are sorted in order of time and combined to create a playlist title 1. More specifically, in the example shown in FIG. 2, since the first set of scenes 51 and the second set of scenes 52 are located separately on the removable medium 31 in ascending order (oldest first) of imaging time periods, the order remains the same as the order shown in FIG. 2 even after the sorting, so that the first set of scenes 51 and the second set of scenes 52 are combined in that order to create the playlist title 1. Although not shown, when the first set of scenes 51 and the second set of scenes 52 are located separately on the removable medium 31 in reverse order (latest first) of imaging time periods, the first set of scenes 51 and the second set of scenes 52 are sorted and thereby rearranged in an order of the second set of scenes 52 and the first set of scenes 51, and the second set of scenes 52 and the first set of scenes 51 are combined in that order to create a playlist title 1.

When a playlist is created according to the first rule and video content on the removable medium 31 is reproduced according to the playlist, scenes with the same date, i.e., events with the same date, are sequentially reproduced in order of their imaging time periods. As described above, the first rule is a most fundamental rule that serves as a basis for creating each playlist title in a date playlist.

Furthermore, in this embodiment, for example, the following second to eighth rules are defined. However, rules other than the first rule are not limited to the second to eighth rules in this embodiment, and rules other than the first rule may be defined as desired by a designer or the like.

### Second Rule

The maximum number of scenes that can be managed is defined as Smax+1, where Smax is a predetermined integer, e.g., 300). “+1” indicates that scenes on and after Smax+1 (301 when Smax is 300) are internally managed collectively as a single scene.

### Third Rule

A scene shorter than a predetermined time, e.g., a scene shorter than 2 seconds, is not included in a playlist title.

### Fourth Rule

The maximum number of scenes having the same date is defined as SSmax, which is a predetermined integer, e.g., 99. That is, when SSmax+1 (100 when SSmax=99) or more scenes having the same date exist, the scenes are sorted in order of time, and the first to SSmax-th scenes among the sorted scenes are combined to form a playlist title of the date, and the (SSmax+1)-th and subsequent scenes are not included in the playlist title.

### Fifth Rule

The maximum number of playlist titles that can be created at once is equal to the number of generated titles, which is restricted by the medium used, such as 30. That is, when 30 playlist titles have been generated on the medium, further playlist titles are not generated. The medium in this embodiment refers to the removable medium 31.

### Sixth Rule

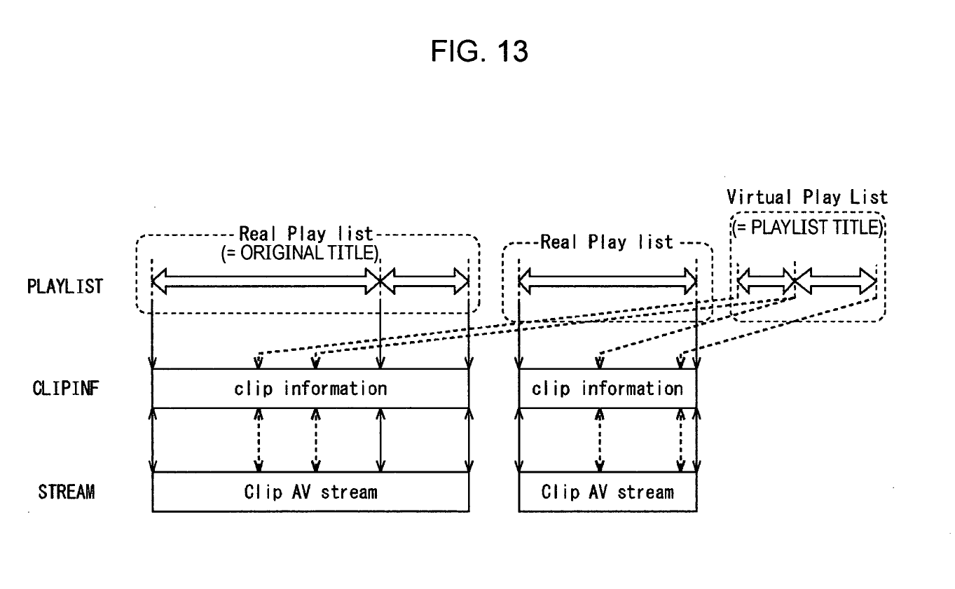

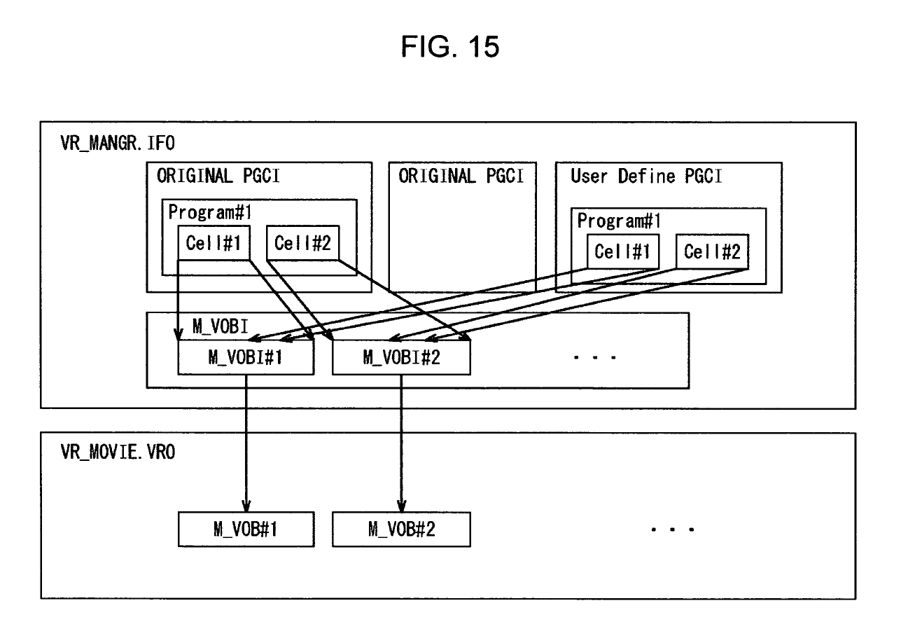

Even when an original title created by dubbing is composed only of events (scenes) of one day, a date playlist is created. The original title refers to a title that is created in advance at the time of assignment of the “Chapter MarkK”. The relationship between the original title and playlist titles in a date playlist will be described later with reference to FIGS. 13 and 15.

### Seventh Rule

A segment in which “REC TIME” is not obtained is not included in a date playlist.

### Eighth Rule

When the time of gap points goes backward, separate playlist titles are not created.

Now, a series of processing steps (hereinafter referred to as a playlist generating process for dubbing) executed by the recording and reproducing apparatus 1 shown in FIG. 1 to create a date playlist according to these rules will be described.

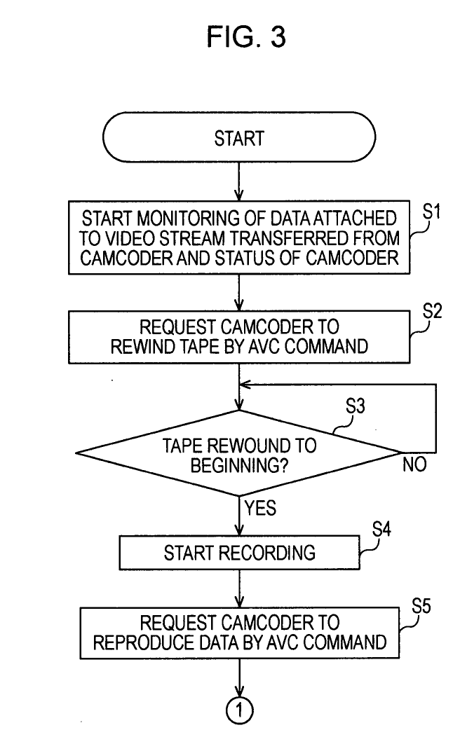

FIG. 3 is a flowchart showing an example of the playlist generating process for dubbing.

In step S1, the controller 11 of the recording and reproducing apparatus 1 shown in FIG. 1 exercises controls so that the communication controller 14 starts monitoring data attached to a video stream supplied from the camcoder 2 and the status of the camcoder 2.

Let it be supposed that video signals including a video stream and data attached to the video stream are supplied from the camcoder 2 to the recording and reproducing apparatus 1.

The data attached to the video stream includes, for example, an “aspect ratio, indicating an aspect ratio of 4:3, 16:9, etc., an “audio emphasis” representing setting information as to whether emphasis is to be applied, an “audio mode”, indicating an audio mode, such as stereo or bilingual, “copy control information”, a “sampling frequency”, a “tape speed”, and a “REC TIME” indicating a date and time (year, month, day, hour, minute, and second) of recording on the digital video tape 32.

As described earlier, a date playlist is generated using “REC TIME” among these pieces of data.

In step S2, the controller 11 exercises control so that the communication controller 14, using an AVC command, requests the camcoder 2 to rewind the digital video tape 32 (hereinafter simply referred to as the tape 32). The AVC command refers to a command in a set of commands that allows operating the camcoder 2 or obtaining status information of the camcoder 2 via an i.LINK cable.

In response to the AVC command, the camcoder 2 rewinds the tape 32.

In step S3, the controller 11 checks whether the tape 32 has been rewound to the beginning.

When it is determined that the tape 32 has not been rewound to the beginning, step S3 results in NO, so that the checking in step S3 is executed again. That is, the checking in step S3 is repeated until the tape 32 is rewound to the beginning. When the tape 32 has been rewound to the beginning, step S3 results in YES, and the process proceeds to step S4.

In step S4, the controller 11 starts recording.

In step S5, the controller 11 exercises control so that the communication controller 14, using an AVC command, requests the camcoder 2 to reproduce data on the tape 32.

In response to the AVC command, the camcoder 2 reproduce data on the tape 32. As a result, video content recorded on the tape 32 is supplied from the camcoder 2 to the recording and reproducing apparatus 1 in the form of a video stream. The video stream has attached thereto various types of data described earlier, including “REC TIME”.

The controller 11 controls the communication controller 14 and the codec chip 15 so that the video stream supplied from the camcoder 2 is sequentially recorded on the removable medium 31 in the form of video data.

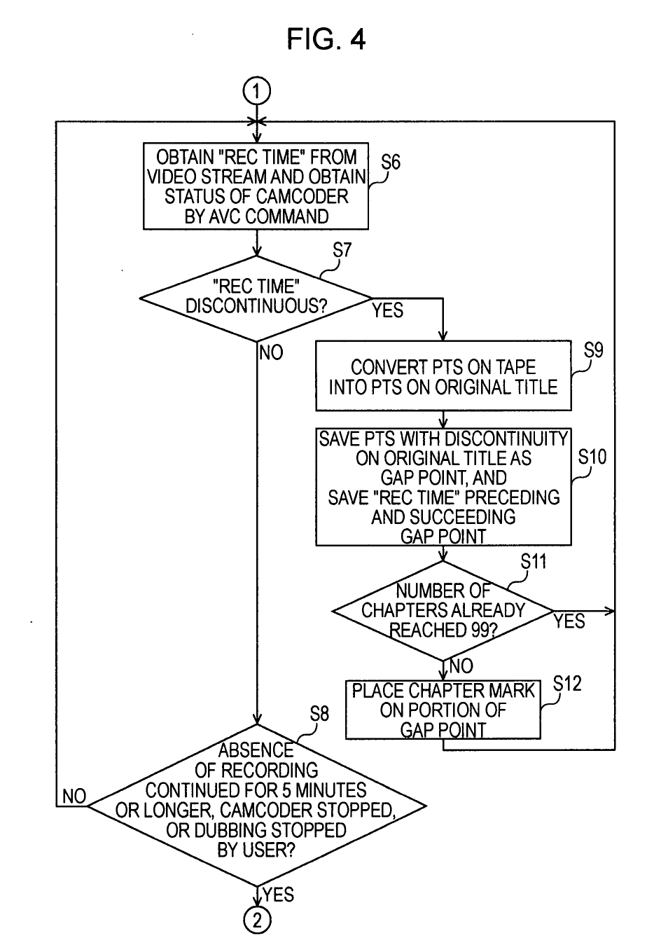

Furthermore, during the recording, in step S6 shown in FIG. 4, the controller 11 controls the communication controller 14 so that the communication controller 14 obtains “REC TIME” from the video stream and obtains status information of the camcoder 2 using an AVC command.

In step S7, the controller 11 checks whether “REC TIME” has become discontinuous.

When “REC TIME” obtained in step S6 in a current iteration represents a time continuous with “REC TIME” obtained in step S6 in a previous iteration, step S7 results in NO, and the process proceeds to step S8.

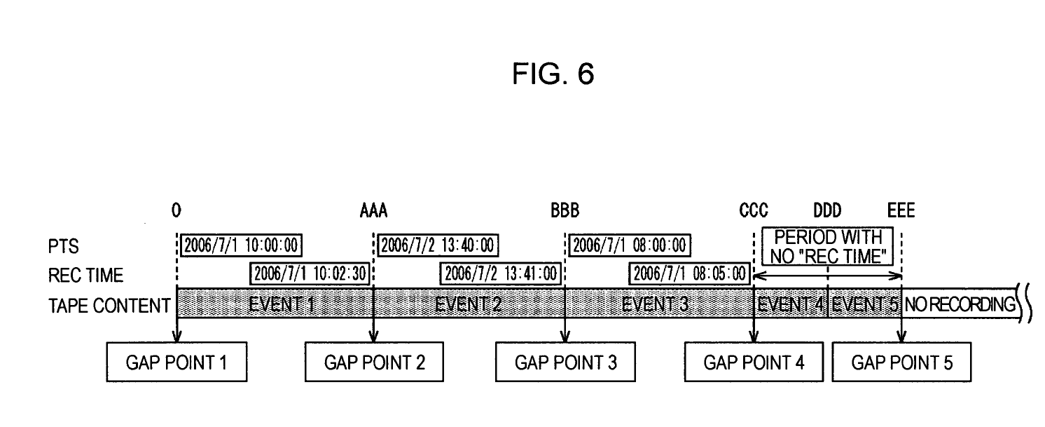

Furthermore, for example, when “REC TIME” is absent as in a case described later with reference to FIG. 6, i.e., when the obtainment of “REC TIME” in step S6 continuously fails, it is not possible to execute steps S9 to S12, which will be described later. Thus, also in this case, step S7 results in NO, and the process proceeds to step S8.

In step S8, the controller 11 checks whether the status of no recording has continued for 5 minutes or longer, whether the camcoder 2 has stopped, and whether the user has stopped dubbing.

When the status of no recording has continued for 5 minutes or longer, when the camcoder 2 has stopped, or when the user has stopped dubbing, step S8 results in YES, and the process proceeds to step S13 in FIG. 5. Processing executed in step S13 and the subsequent steps will be described later.

On the other hand, when the status of no recording has not continued for 5 minutes or longer, the camcoder 2 has not stopped, and the user has not stopped dubbing, step S8 results in NO, and the process returns to step S6 and the subsequent steps are repeated.

That is, as long as the status of no recording has not continued for 5 minutes or longer, the camcoder 2 has not stopped, the user has not stopped dubbing, and “REC TIME” obtained in step S6 in the current iteration indicates a time continuous with “REC TIME” obtained in step S6 in the previous iteration, the process repeats the loop of steps S6, S7 (NO), and S8 (NO).

When the time represented by “REC TIME” in step S6 in the current iteration has become discontinuous with the time represented by “REC TIME” obtained in step S6 in the previous iteration, step S7 results in YES, and the process proceeds to step S9.

Furthermore, for example, when the process has proceeded to step S7 as a result of step S6 in an initial iteration, when the obtainment of “REC TIME” has succeeded in step S6 after failures in previous iterations, or conversely when the obtainment of “REC TIME” has failed in step S6 after successes in previous iterations, step S7 results in YES, and the process proceeds to step S9.

In step S9, the controller 11 converts presentation time stamps (PTSs) on the tape 32 into PTSs on the original title. That is, step S9 is executed since reproduction of a portion corresponding to “REC TIME” just obtained in step S6 in the video stream is not always possible.

In step S10, the controller 11 saves the PTS associated with a discontinuity on the original title as a gap point, and also saves preceding and succeeding “REC TIME”.

In step S11, the controller 11 checks whether the number of chapters has already reached 99.

When the number of chapters has already reached 99, step S11 results in YES, and the process returns to step S6 and the subsequent steps are repeated.

On the other hand, when the number of chapters is less than or equal to 98, step S11 results in NO, and the process proceeds to step S12. In step S12, the controller 11 places a chapter mark in the portion of the gap point. The process then returns to step S6, and the subsequent steps are repeated.

When the status of no recording has continued for 5 minutes or longer, when the camcoder 2 has stopped, or the user has stopped dubbing, step S8 results in YES, and the process proceeds to step S13 shown in FIG. 5, as described earlier.

In step S13, the controller 11 stops recording, and sets an original title name. The method of setting the original title name is not particularly limited. For example, in this embodiment, a newest time and an oldest time are obtained from values of “REC TIME” and the original title name is set using the newest time and the oldest time.

In step S14, the controller 11 controls the communication controller 14 to check whether the camcoder 2 has stopped.

When it is determined in step S14 that the camcoder 2 has not stopped, in step S15, the controller 11 controls the communication controller 14 to request using an AVC command that the camcoder 2 be stopped. Then, the process proceeds to step S16.

On the other hand, when it is determined in step S14 that the camcoder 2 has stopped, the process skips step S15 and directly proceeds to step S16.

That is, step S16 is executed when the camcoder 2 has stopped.

In step S16, the controller 11 creates scenes using information such as “REC TIME” saved in step S10 shown in FIG. 4, and classifies and sorts the scenes on the basis of dates in ascending order, thereby generating data for creating individual playlist titles in a date playlist (hereinafter referred to as date-title creating data).

Then, the process proceeds to step S17 shown in FIG. 10, and the subsequent steps are executed. That is, each playlist title in a date playlist is created using the corresponding date-title creating data.

Before describing step S17 and the subsequent steps shown in FIG. 10, processing executed in step S16, i.e., processing for generating date-title creating data, will be described in detail with reference to specific examples shown in FIGS. 6 to 9.

For example, let it be assumed that video content indicated as “tape content” in FIG. 6 has been recorded on the digital video tape 32 and the video content is dubbed on the removable medium 31. That is, let it be assumed that video signals including a video stream corresponding to the “tape content” shown in FIG. 6 and additional information such as “PTS” and “REC TIME” has been supplied from the camcoder 2 to the recording and reproducing apparatus 1. “PTS” in FIG. 6 represent an example of values on the original title obtained through conversion in step S9.

The reason that a point with “PTS” indicating “DDD” is not a gap point is as follows. Since “REC TIME” does not exist in the period with “PTS” indicating “CCC” to “EEE”, it is not possible to execute the checking in step S7 shown in FIG. 4. Thus, step S7 is forced to result in NO, so that steps S9 to S12 are not executed. Accordingly, no gap point is detected.

Furthermore, regarding periods preceding and succeeding “PTS” indicating “EEE”, “REC TIME” does not exist in the period preceding “EEE”, whereas “REC TIME” exists immediately after “EEE”. In this case, step S7 results in YES, so that steps S9 to S12 are executed. Accordingly, “gap point 5” is detected.

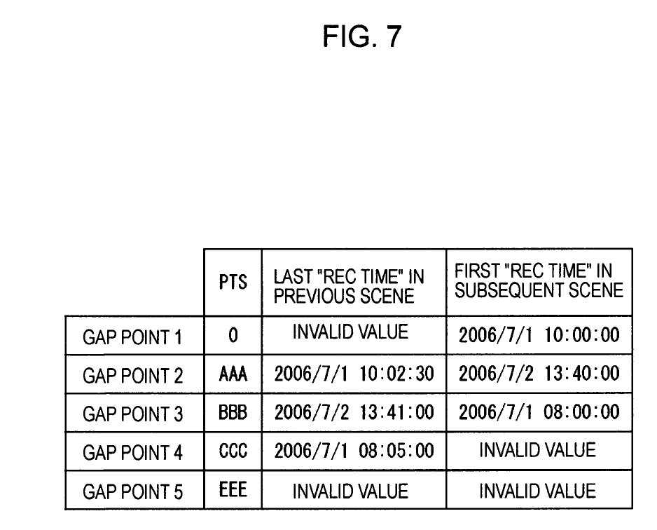

When the video stream corresponding to the “tape content” shown in FIG. 6 has been sequentially supplied from the camcoder 2 to the recording and reproducing apparatus 1, the loop formed of steps S6 to S12 shown in FIG. 4 is repeated so that step S10 is executed in each iteration of the loop. As a result, at the time of start of step S16 shown in FIG. 5, information shown in the form of a table in FIG. 7 (hereinafter referred to as information in FIG. 7) has been saved.

“PTS” in FIG. 7 indicates a “point of discontinuity on the original title” in step S10 shown in FIG. 4. “Last ‘REC TIME’ in preceding scene” in FIG. 7 refers to “REC TIME” of the preceding period among the “REC TIME” of the preceding and succeeding periods. On the other hand, “First ‘REC TIME’ of the succeeding scene” in FIG. 7 refers to “REC TIME” of the succeeding period among the “REC TIME” of the preceding and succeeding periods. Thus, hereinafter, “Last ‘REC TIME’ in preceding scene” in FIG. 7 will be referred to as “REC TIME” preceding “PTS” on the same row in FIG. 7, and “First ‘REC TIME’ of the succeeding scene” in FIG. 7 will be referred to as “REC TIME” succeeding “PTS” on the same row.

When the information shown in FIG. 7 has been saved, the controller 11 executes the following series of steps in step S16.

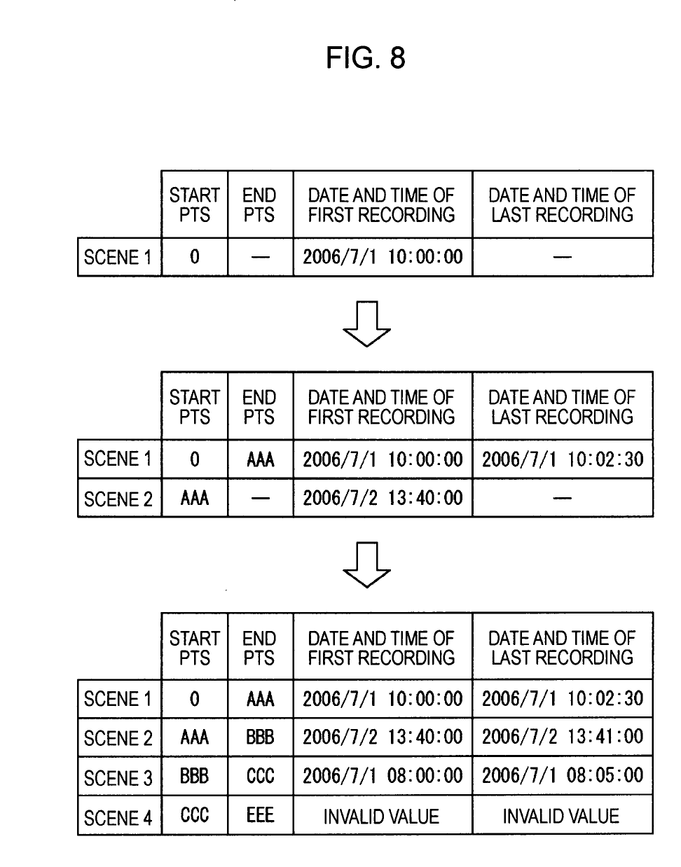

That is, first, using “PTS” and preceding and succeeding “REC TIME” included in the information shown in FIG. 7, as shown in FIG. 8, the controller 11 generates information (hereinafter referred to as scene data) including “start PTS”, “end PTS”, first recording date and time”, and “last recording date and time” as information for identifying “scene 1” to “scene 4” individually.

For example, scene data of a scene M (M is an integer, and is one of the values 1 to 4 in the example shown in FIG. 8) is generated as follows.

When M is 1, the first “PTS” (“0” in the example shown in FIG. 8) is the “start PTS”, and when M is 2 or greater, the “end PTS” of the immediately preceding scene M−1 is the “start PTS” and the next “PTS” is the “end PTS”. Furthermore, “REC TIME” succeeding the “start PTS” is the “first recording date and time” of the scene M, and “REC TIME” preceding the “last PTS” is the “last recording date and time” of the scene M. In this case, the video content from the “first recording date and time” to the “last recording date and time” constitutes the scene M.

In this manner, individual scene data of “scene 1” to “scene 4” shown in the table in the lower part of FIG. 8 is generated.

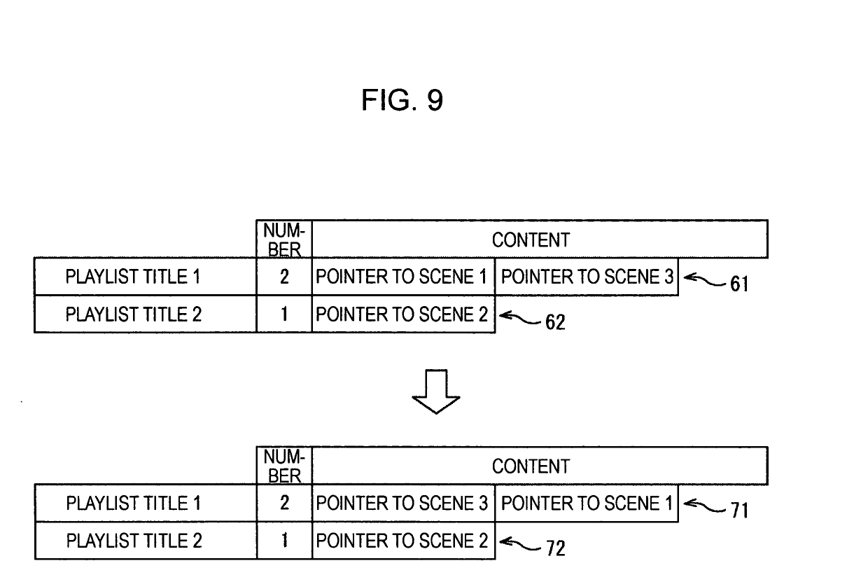

Next, as shown in an upper part of FIG. 9, the controller 11 generates data in which “scene 1” to: “scene 4” are classified on the basis of individual dates. In the example shown in FIG. 9, data 61 for “scene 1 and “scene 3” having a date “2006/7/1” and data 62 for “scene 2 and “scene 4”, having a date “2006/7/2” are generated.

In the data 61 and the data 62, a “pointer to scene M” refers to information pointing to scene data of the scene M. That is, since inclusion of scene data in the data 61 or the data 62 results in doubly holding the same scene data in a memory such as the RAM 13 shown in FIG. 1, a pointer not including actual data is used for the data 61 or the data 62.

In generating data classified on the basis of individual dates, scenes having invalid values as the “first recording date and time” or the “last recording date and time”, such as “scene 4” shown in FIG. 8, are disregarded. Similarly, although not shown in the example in FIG. 8, scenes with lengths between the “first recording date and time” and the “last recording date and time” shorter than or equal to 2 seconds are also disregarded.

Furthermore, from the data classified on the basis of individual dates, the controller 11 generates data in which individual scenes are sorted in order of time. This data serves as date-title creating data for each date.

In the case of the example shown in FIG. 9, from the data 61 for “scene 1” and “scene 3”, having the date “2006/7/1”, date-title creating data 71 for the date “2006/7/1” is created. That is, since the imaging time period of “scene 3” is older than the imaging time period of “scene 1”, i.e., since “scene 3” was captured earlier and “scene 1” was captured later, the date-title creating data 71 is generated by rearranging the data 61 in order of the “pointer to scene 3” and the “pointer to scene 1”.

Furthermore, from the data 62 for “scene 2” having the date “2006/7/2”, the date-title creating data 72 for “2006/7/2” is generated. Since “scene 2”, is the only scene having the date “2006/7/2”, the date-title creating data 72 is substantially the same as the data 62.

The date-title creating data of each date is generated as a result of step S16 shown in FIG. 5. The process then proceeds to step S17 shown in FIG. 10.

In step S17, the controller 11 calculates a restriction of the medium (i.e., the number of titles that can be newly created on the medium). For example, in this embodiment, the controller 11 calculates a restriction of the removable medium 31 shown in FIG. 1. More specifically, for example, according to the fifth rule described earlier, assuming that the number of titles that have already been created on the removable medium 31 is Q, (where Q is an integer in a range of 0 to 30), a restriction indicating that the number of playlist titles that can be included in a date playlist is (30-Q) is calculated.

In step S18, the controller 11 reads date-title creating data of a specific date. In the case of the example shown in FIG. 9, the controller 11 reads the date-title creating data 71 of the date “2006/7/1” or the date-title creating data 72 of the date “2006/7/2”.

In step S19, the controller 11 creates a playlist title of the specific date using the first scene data in the date-title creating data of the specific date, more specifically, scene data indicated by the first pointer in the date-title creating data of the specific date.

For example, when the date-title creating data 71 of the date “2006/7/1” is read in step S18, in step S19, a playlist title of the date “2006/7/1” is created using the scene data of “Scene 3”.

On the other hand, when the date-title creating data 72 of the date “2006/7/2” is read in step S18, in step S19, a playlist title of the date “2006/7/2” is created using the scene data of “Scene 2”.

In step S20, the controller 11 checks the scene data is the last scene data in the date-title creating data of the specific date.

When it is determined in step S20 that the scene data is not the last scene data in the date-title creating data of the specific date, the process proceeds to step S21. In step S21, the controller 11 merges the next scene data in the date-title creating data of the specific date, more specifically, scene data indicated by the next pointer in the date-title creating data of the specific date, with the playlist title of the specific date.

Then, the process returns to step S20, and the subsequent steps are repeated. That is, pieces of scene data in the date-title creating data of the specific date, more specifically, pieces of scene data indicated individually by pointers in the date-title creating data of the specific date are sequentially merged with the playlist title of the specific date in order of time. When the last scene data has been merged, step S20 results in YES, and the process proceeds to step S22.

For example, when the date-title creating data 71 of the date “2006/7/1” is read in step S18 and a playlist title of the date “2006/7/1”, is created using scene data of “Scene 3”, scene data of “Scene 1” is remaining. Thus, step S20 results in NO, and in step S21, scene data of “Scene 1”, is merged with the playlist title of the date “2006/7/1”. Since the scene data of “Scene 1” is the last scene data, step S20 in the next iteration results in YES, and the process proceeds to step S22.

On the other hand, when the date-title creating data 72 of the date “2006/7/2”, is read in step S18 and a playlist title of the date “2006/7/2” is created using scene data of “Scene 2” in step S19, no other scene data exists, i.e., the scene data of “Scene 2” is the last scene data. Thus, step S20 immediately results in YES, and the process proceeds to step S22 without executing step S21 at all.

In step S22, the controller 11 sets a name of the playlist title of the specific date.

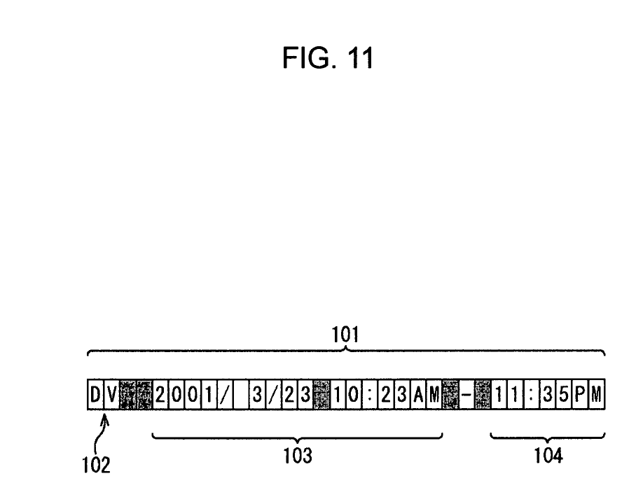

The method of setting the name is not particularly limited. For example, in this embodiment, a name 101 shown in FIG. 11 is set. That is, the name 101 of the playlist title of the specific date is represented by a string of up to 32 characters.

More specifically, a character string 102 of the first two characters represents a type of a video stream supplied from the camcoder 2. In the example shown in FIG. 11, the character string 102 represents “DV”, which indicates that the video stream is a digital video (DV) stream. As another example, the character string 102 may represent “HD”, which indicates a high-definition digital video (HDV) stream.

A character string 103 indicates an earliest recording date and time (year/month/day time AM or PM) of video content that is reproduced according to the playlist title of the specific date. A character string 104 indicates a latest recording date and time (time AM or PM) of video content that is reproduced according to the playlist title of the specific date. That is, according to the playlist title having the name 101, video content from the recording date and time indicated by the character string 103 to the recording date and time indicated by the character string 104 is reproduced. In the case of the example shown in FIG. 11, video content captured during the period from 2001/3/23 10:23 AM” to “11:35 PM” on the same day is reproduced.

Referring back to FIG. 10, after setting the name of the playlist title of the specific date in step S22, the process proceeds to step S23.

In step S23, the controller 11 controls the codec chip 15 so that the playlist title of the specific date is written to the removable medium 31 via the drive 17.

In step S24, the controller 11 checks whether date-title creating data with which a playlist title has not been created exists and the date-title creating data does not violate the media restriction calculated in step S17.

When date-title creating data with which a playlist title has not been created exists and the date-title creating data does not violate the media restriction calculated in step S17, the process returns to step S18, and the subsequent steps are repeated.

As described above, through repeated execution of the loop formed of steps S18 to S24, playlist titles of individual dates are created. That is, a date playlist including the playlist titles of the individual dates is generated. When the date playlist has been generated, step S24 results in NO, and the process proceeds to step S25.

In step S25, the controller 11 controls the codec chip 15 so that flushing of the removable medium 31 (fixing of the filesystem) is executed.

When the flushing is finished, the entire playlist generating process for dubbing is finished.

When the playlist generating process for dubbing has been executed as described above, video data dubbed from the digital video tape 32, original titles, a date playlist, and so forth are recorded on the removable medium 31.

Since the directory structure differs between a case where the removable medium 31 is a DVD and a case where the removable medium 31 is a BD, the structure of arrangement of various types of data also differs between these cases.

Thus, overviews of the structure of data arrangement in a BD and the structure of data arrangement in a DVD will be described with reference to FIGS. 12 to 15.

FIG. 12 shows an example of the structure of data arrangement in a BD.

In the example shown in FIG. 12, “Root” is the root directory. Under “Root”, a directory (folder) relating to video content is provided, which is “BDAV” in the example shown in FIG. 12.

In the example shown in FIG. 12, under “BDAV”, “PLAYLIST” is provided as a folder for storing playlists, “CLIPINF” is provided as a folder for storing additional information of video data, and “STREAM” is provided as a folder for storing actual video data (MPEG-TS).

In “PLAYLIST”, original titles are stored in files having extensions “rpls”, such as “01001.rpls” and “02002.rpls”. On the other hand, playlist titles of a specific date in a date playlist are stored in a file having an extension “vpls”, such as “9999.vpls”. That is, a date playlist is a set of files having extensions “vpls”.

In “STREAM”, files having extensions “m2ts”, such as “01000.m2ts”, “02000.m2ts”, and “03000.m2ts”, store actual video data (MPEG-TS). That is, when the playlist generating process for dubbing, described earlier, is executed once, video data dubbed from the digital video tape 32 is recorded under “STREAM” in the form of a single file having an extension “m2ts”.

Furthermore, additional information of each piece of video data is recorded under “CLIPINF” in the form of a file having a name corresponding to the file name of the video data and having an extension “clip”. More specifically, in the case of the example shown in FIG. 12, “01000.clip” includes information associated with the video data in “01000.m2ts”, i.e., information such as chapter marks and gap points described earlier. Furthermore, information attached to the video stream supplied from the camcoder 2, such as “REC TIME” described earlier, may be included. Similarly, “02000.clip” includes additional information associated with video data in “02000.m2ts”, and “03000.clip” includes additional information associated with video data in “03000.m2ts”.

FIG. 13 shows relationship among “PLAYLIST”, “CLIPINF”, and “STREAM”.

In FIG. 13, “Real Play list” in “PLAYLIST” represents an original title, i.e., content of a file having an extension “rpls”. On the other hand, “Virtual Play list” represents playlist titles of a specific date in a date playlist, i.e., content of a file having an extension “vpls”.

Furthermore, a “Clip AV stream” in “STREAM” represents content of a file having an extension “m2ts”, i.e., actual video data corresponding to a file (MPEG-TS). A piece of “Clip information” in “CLIPINF” on “Clip AV stream” represents additional information of associated video data, i.e., content of a file having a name corresponding to the file name of the video data and having an extension “clip”.

As shown in FIG. 13, “clip information” and “Clip AV stream” has a one-to-one relationship. In this case, considering that video content corresponding to “Clip AV stream” is a set of units referred to as “clips”. Leach arrow shown in “Real Play list” indicates one “clip”. That is, “Real Play list” is a set of start points and end points of individual “clips”, and information specifying the start points and the end points is included in “clip information”. Since each playlist title in a date playlist is a set of one or more scenes having the same date, by considering the scenes as one “clip”, “Virtual Play list” can be configured similarly to “Real Play list”. That is, each arrow in “Virtual Play list” in FIG. 13 represents each scene included in playlist titles.

Furthermore, in the example shown in FIG. 13, “Virtual Play list” includes a set of start points and end points of individual “clips” of two different “Clip AV streams”. “Virtual Play list” in the example shown in FIG. 13 indicates that when each of a plurality of “Clip AV streams” includes one or more scenes having the same date, it is possible to create a playlist title in which the scenes having the same date are combined and sorted in order of time.

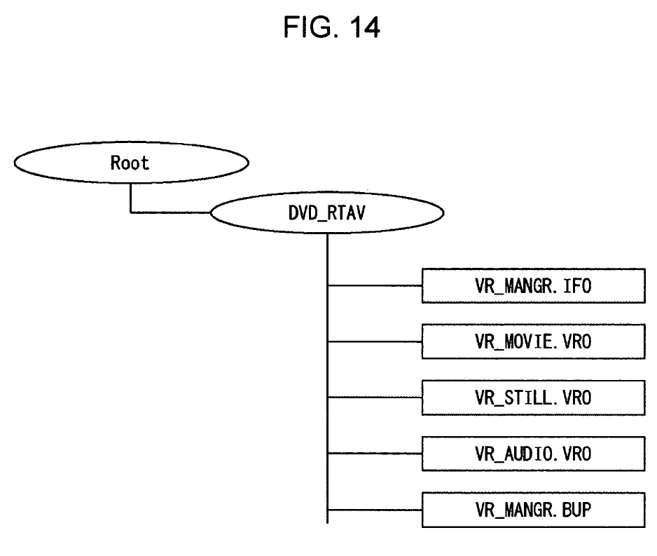

As opposed to the structure of data arrangement in a BD, described above, FIG. 14 shows the structure of data arrangement in a DVD.

In the example shown in FIG. 14, an ellipse represents a directory, and a rectangle represents a file. More specifically, in the example shown in FIG. 14, “Root” is the root directory. Under “Root”, a directory (folder) relating to video content is provided, which is “DVD_RTAV” in the example shown in FIG. 14.

“DVD_RTAV” includes five types of files, namely, “VR_MANGR.IFO”, “VR_MOVIE.VRO”, “VR_STILL.VRO”, “VR_AUDIO.VRO”, and “VR_MANGR.BUP”.

“VR_MANGR.IFO” includes title management data, i.e., management data of original titles, and management data of playlist titles of each date in a date playlist. “VR_MANGR.BUP” is a backup file for “VR_MANGR.IFO”.

“VR_MOVIE.VRO” stores actual video data (moving-picture and audio data) (MPEG-PS). “VR_STILL.VRO” stores actual still-picture data. “VR_AUDIO.VRO” stores actual attached audio data.

FIG. 15 shows relationship between “VR_MANGR.IFO” and “VR_STILL.VRO”.

In “VR_MANGR.IFO”, “ORIGINAL PGCI” represents management information of an original title. On the other hand, “User Define PGCI” represents management information of a user-defined title. Thus, “User Define PGCI” can be used as management information of each playlist title in a date playlist. M_VOBI” stores additional information of associated video data.

The series of processes described above can be executed either by hardware or by software. When the series of processes is executed by software, a programs constituting the software is installed from a program recording medium onto a computer embedded in special hardware, or a computer including the codec chip 15, the controller 11, or the like of the recording and reproducing apparatus 1 shown in FIG. 1 or a general-purpose computer capable of executing various functions with various programs installed thereon.

As shown in FIG. 1, the program recording medium storing the program that is to be installed on a computer for execution by the computer may be the removable medium 31, which is a package medium such as a magnetic disc (e.g., a flexible disc), an optical disc (e.g., a compact disc read-only memory (CD-ROM)) or a digital versatile disc (DVD)), a magneto-optical disc, a semiconductor memory, or the like, the ROM 12 in which the program is stored temporarily or permanently, or a hard disk forming the storage unit 16. The program can be stored on the program recording medium through a wired or wireless communication medium, such as a local area network, the Internet, or digital satellite broadcasting, via the communication controller 14 as needed.

In this specification, steps defining the program stored on the program recording medium need not necessarily be executed sequentially in the orders described herein, and may include steps that are executed in parallel or individually.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
an obtaining unit configured to obtain stream data, the stream data including one or more events captured by an imaging device and arranged in an order that is independent of a time order of time periods of capturing of the individual events, and to obtain additional information including start times and end times of the time periods of capturing of the individual events;
a recording controller configured to exercise control so that the stream data obtained by the obtaining unit is recorded on a recording medium; and
a generating unit configured to generate a date playlist on the basis of the additional information obtained by the obtaining unit, the date playlist allowing individual reproduction of titles associated with individual dates, each of the titles being a collection of one or more events having the same date and sorted in order of time among the events captured by the imaging device.

2. The information processing apparatus according to claim 1, wherein the recording controller further exercises control so that the date playlist generated by the generating unit is recorded on the recording medium.

3. The information processing apparatus according to claim 1, wherein when the generating unit generates the playlist, the generating unit excludes one or more events for each of which the obtaining unit failed to obtain at least one of the start time and the end time among the events captured by the imaging device.

4. The information processing apparatus according to claim 1, wherein when the generating unit generates the playlist, the generating unit excludes one or more events for each of which the time period of capturing has a length less than or equal to a predetermined time among the events captured by the imaging device.

5. An information processing method of an information processing apparatus including an obtaining unit configured to obtain stream data, the stream data including one or more events captured by an imaging device and arranged in an order that is independent of a time order of time periods of capturing of the individual events, and to obtain additional information including start times and end times of the time periods of capturing of the individual events, and including a recording controller configured to exercise control so that the stream data obtained by the obtaining unit is recorded on a recording medium, the information processing method comprising the step of:
generating a date playlist on the basis of the additional information obtained by the obtaining unit, the date playlist allowing individual reproduction of titles associated with individual dates, each of the titles being a collection of one or more events having the same date and sorted in order of time among the events captured by the imaging device.

6. A program that is executed by a computer that controls a recording apparatus including an obtaining unit configured to obtain stream data, the stream data, including one or more events captured by an imaging device and arranged in an order that is independent of a time order of time periods of capturing of the individual events, and to obtain additional information including start times and end times of the time periods of capturing of the individual events, and including a recording controller configured to exercise control so that the stream data obtained by the obtaining unit is recorded on a recording medium, the program comprising the step of:
generating a date playlist on the basis of the additional information obtained by the obtaining unit, the date playlist allowing individual reproduction of titles associated with individual dates, each of the titles being a collection of one or more events having the same date and sorted in order of time among the events captured by the imaging device.
